(19) United States
(12) Patent Application Publication
(10) Pub. No.: US 2012/0297232 A1
(43) Pub. Date: Nov. 22, 2012

(54) ADJUSTING THE CLOCK FREQUENCY OF A PROCESSING UNIT IN REAL-TIME BASED ON A FREQUENCY SENSITIVITY VALUE

(76) Inventor: William L. Bircher, Austin, TX (US)

(21) Appl. No.: 13/108,165

(22) Filed: May 16, 2011

(51) Int. Cl. G06F 1/04

(52) U.S. Cl. 713/500

(57) ABSTRACT

A system, method, and medium for adjusting an input clock frequency of a processor in real-time based on one or more hardware metrics. First, the processor is characterized for a plurality of workloads. Next, the frequency sensitivity value of the processor for each of the workloads is calculated. Hardware metrics are also monitored and the values of these metrics are stored for each of the workloads. Then, linear or polynomial regression is performed to match the metrics to the frequency sensitivity of the processor. The linear or polynomial regression will produce a formula and coefficients, and the coefficients are applied to the metrics in real-time to calculate a frequency sensitivity value of an application executing on the processor. Then, the frequency sensitivity value is utilized to determine whether to adjust the input clock frequency of the processor.

### BACKGROUND OF THE INVENTION

1. Field of the Invention

This disclosure relates generally to processing units, and in particular to a system, method, and medium of adjusting the input clock frequency of a processing unit based on the frequency sensitivity of the processing unit.

2. Description of the Related Art

There are many approaches to optimizing the performance of a processing unit in a computer system. One common approach involves adjusting the input clock frequency of the processing unit according to the activity level of the processing unit. In traditional approaches of adjusting the clock frequency of a processing unit, decisions about whether to increase or reduce the clock frequency are made at the software level by the operating system. In some processor architectures, the different states of the processor, corresponding to the different frequencies available to clock the processor, are known as P states.

The decisions made at the software level about setting the frequency are often made haphazardly. The software does not have access to information about what the tradeoffs are for raising or lowering the frequency, and as a result, the software uses crude methods for estimating the optimum frequency to clock the processor. What is missing from the software is information on how a given processor or core would benefit from a particular clock frequency.

For example, in one common approach, the operating system may determine that a certain processor core is active (i.e., using up most of its active clock cycles). As a result, the operating system may increase the clock frequency of the core. However, if the processor core is memory-bounded, such that it is waiting on accesses to memory, then an increase in clock frequency will not offer any benefit to the application running on the core.

When a processing workload is memory-bounded, the processing unit may perform frequent accesses of main memory. Since the latency associated with main memory accesses can be orders of magnitude greater than a processor cycle time, a memory-bounded workload may be much less sensitive to the processor's operating frequency. More particularly, memory accesses may cause a processor to stall, since the duration of these stalls is a function of memory access latency. The latency associated with memory accesses is a function of the memory bus clock frequency, which is typically much lower than the core clock frequency. Therefore, increases in the core clock frequency typically do not result in corresponding performance increases in the processing of memory-bounded workloads. Moreover, reducing the core clock frequency when processing a memory-bounded workload does not typically result in a corresponding loss of performance, since memory access latency is usually the limiting factor in determining the speed at which these workloads may be executed.

Therefore what is needed in the art is a decision-making approach to frequency adjustment that is based on how the core or program would actually benefit from an increase in the clock frequency. In view of the above, improved systems, methods, and mediums for tuning processor clock frequencies are desired.

### SUMMARY OF EMBODIMENTS

Various embodiments of systems, methods and mediums for adjusting an input clock frequency to a processing unit are contemplated. In one embodiment, a training session may be implemented for the processing unit using one or more pre-defined benchmark workloads. For each of the pre-defined workloads, the performance value of the processing unit may be measured at two or more input clock frequencies. Additionally, measurements of one or more hardware performance counters may be taken and stored at one or more clock frequencies. The training session may be used to characterize the performance and frequency sensitivity of the processing unit.

In various embodiments, the one or more hardware performance counters may measure instructions per cycle (IPC), memory controller bandwidth, committed instructions per second (CIPS), cache hits, cache misses, branch mispredictions, instructions issued, interrupts, non-cache accesses, pipeline stalls, and/or other metrics. The hardware performance counters may reside in a variety of locations. In some embodiments, one or more of the hardware performance counters may be accessed directly by a processing unit, power management unit, performance monitoring unit, or other hardware unit or software program. In various embodiments, the measurement values of one or more of the hardware performance counters may be written to a memory device, and then the values may be accessed from the memory device by a hardware unit or software program.

As a result of the information obtained in the training session, a frequency sensitivity value of the processing unit may be calculated for each pre-defined workload. The training session frequency sensitivity value may be based on the performance values of the processing unit at two or more input clock frequencies. Then, linear regression may be performed on the one or more stored measurements of the hardware performance counters to match the calculated frequency sensitivity values. If linear regression with a single hardware performance counter does not produce sufficiently accurate results, such as results that meet a predetermined accuracy level, linear regression using multiple metrics may be executed. If multiple linear regression does not produce sufficiently accurate results, polynomial regression may be executed. After sufficiently accurate results have been obtained, the results of the best-fit regression model may be stored. The best-fit regression model may include one or more coefficients to apply to one or more metrics.

In various embodiments, the hardware performance counters and the one or more coefficients from the best-fit regression model may be utilized to calculate the frequency sensitivity of an application executing on the processing unit in real-time. Based on the real-time frequency sensitivity value of an application executing on the processing unit, the clock frequency of the processing unit may be adjusted. The operating voltage of the processing unit may also be adjusted based on the real-time frequency sensitivity value of the application. In various embodiments, if the application has a high frequency sensitivity value, then the clock frequency of the processing unit may be increased. If the application has a low frequency sensitivity value, then the clock frequency of the processing unit may be decreased. Variations on this clock frequency adjustment scheme may also be implemented in accordance with the methods and mechanism described herein. In various embodiments, the clock frequency may be adjusted to an optimum frequency for maximizing performance per watt of the processing unit. The optimum frequency may be determined based on the real-time frequency sensitivity value and additional information, such as a power number associated with a particular performance state of the processing unit.

In various embodiments, the power management unit may receive a request to adjust the clock frequency of a processing unit or core. An operating system, software application, other processing unit, or other component may convey the request to the power management unit. The power management unit may determine whether to comply with the request based on the real-time frequency sensitivity value.

In various embodiments, a computer system may include two or more processing units. The power management unit may be configured to monitor the performance of two or more processing units. The power management unit may also be configured to determine the value of one or more hardware performance counters corresponding to each of the processing units. Additionally, the power management unit may also be configured to calculate a real-time frequency sensitivity value of each application executing on each of the two or more processing units, wherein the real-time frequency sensitivity value units is based on the one or more hardware performance counters. The frequency of the input clock coupled to each of the two or more processing units may be adjusted based on the corresponding real-time frequency sensitivity value

These and other features and advantages will become apparent to those of ordinary skill in the art in view of the following detailed descriptions of the approaches presented herein.

### BRIEF DESCRIPTION OF THE DRAWINGS

The above and further advantages of the systems, methods, and mechanisms may be better understood by referring to the following description in conjunction with the accompanying drawings, in which:

FIG. 1 illustrates one embodiment of a computer system including a processor.

FIG. 2 is a block diagram of an integrated circuit coupled to a memory in accordance with one or more embodiments.

FIG. 3 illustrates a block diagram of one embodiment of a processing unit.

FIG. 4 illustrates one embodiment of a method for creating a model of the frequency sensitivity of a processing unit.

FIG. 5 illustrates one embodiment of a power management unit.

FIG. 6 is a block diagram of another embodiment of a power management unit.

FIG. 7 is a block diagram of a decision unit in accordance with one or more embodiments.

FIG. 8 illustrates a frequency sensitivity calculation unit in accordance with one or more embodiments.

FIG. 9 illustrates a block diagram of another embodiment of a frequency sensitivity calculation unit.

### DETAILED DESCRIPTION

In the following description, numerous specific details are set forth to provide a thorough understanding of the methods and mechanisms presented herein. However, one having ordinary skill in the art should recognize that the various embodiments may be practiced without these specific details. In some instances, well-known structures, components, signals, computer program instructions, and techniques have not been shown in detail to avoid obscuring the approaches described herein. It will be appreciated that for simplicity and clarity of illustration, elements shown in the figures have not necessarily been drawn to scale. For example, the dimensions of some of the elements may be exaggerated relative to other elements.

This specification includes references to “one embodiment”. The appearance of the phrase “in one embodiment” in different contexts does not necessarily refer to the same embodiment. Particular features, structures, or characteristics may be combined in any suitable manner consistent with this disclosure.

Terminology. The following paragraphs provide definitions and/or context for terms found in this disclosure (including the appended claims):

“Comprising.” This term is open-ended. As used in the appended claims, this term does not foreclose additional structure or steps. Consider a claim that recites: “A system comprising a processor unit . . . .” Such a claim does not foreclose the system from including additional components (e.g., a network interface unit, graphics circuitry, etc.).

“Configured To.” Various units, circuits, or other components may be described or claimed as “configured to” perform a task or tasks. In such contexts, “configured to” is used to connote structure by indicating that the units/circuits/components include structure (e.g., circuitry) that performs the task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation, etc. Reciting that a unit/circuit/component is “configured to” perform one or more tasks is expressly intended not to invoke 35 U.S.C. §112, sixth paragraph, for that unit/circuit/component. Additionally, “configured to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks.

“First,” “Second,” etc. As used herein, these terms are used as labels for nouns that they precede, and do not imply any type of ordering (e.g., spatial, temporal, logical, etc.). For example, in a processor having eight processing elements or cores, the terms “first” and “second” processing elements can be used to refer to any two of the eight processing elements. In other words, the “first” and “second” processing elements are not limited to logical processing elements 0 and 1.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

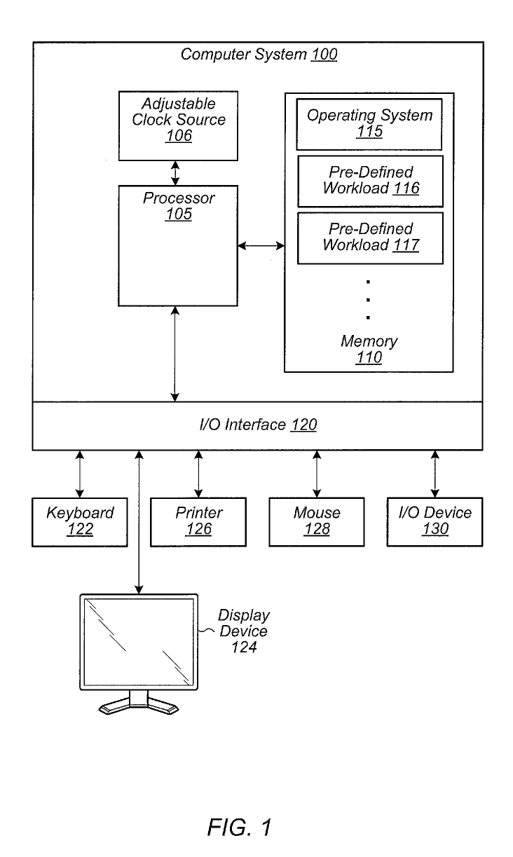

Referring to FIG. 1, one embodiment of a computer system including a processor is shown. Processor 105 may be any of various processing units, as desired. For example, processor 105 may be a central processing unit (CPU) of various types, including an x86 processor, an Advanced Micro Devices (AMD) Athlon™ processor, an AMD Phenom™ processor, an Intel Pentium™ class processor, a Motorola PowerPC™ processor, a CPU from the Oracle SPARC™ family of RISC processors, an ARM processor, as well as others. Other processor types such as microprocessors, graphics processing units (GPU's), or other types are envisioned. Additionally, processor 105 may be a single-core or multi-core processor. In various embodiments, processor 105 may be representative of one or more CPU's and one or more GPU's within a computing system. Other variations of systems and processors are possible and are contemplated. Computer system may also include adjustable clock source 106. Adjustable clock source 106 may provide a clock frequency to processor 105, and source 106 may be configurable to provide one of a plurality of clock frequencies to processor 105.

As shown in FIG. 1, computer system 100 may also include a memory medium 110, typically comprising RAM and referred to as main memory, which may be coupled to a host bus by means of a memory controller (not shown). Memory 110 may be configured to store an operating system 115 as well as application programs and other software for operation of the computer system. Memory 110 may also store pre-defined workloads 116 and 117, which are representative of any number of workloads. Workloads 116 and 117 may also represent the variety of applications that processor 105 may be expected to execute in typical operating conditions. In other embodiments, workloads 116 and 117 may be stored in other locations. For example, in one embodiment, processor 105 may access workloads 116 and 117 from I/O device 130 via I/O interface 120.

Processor 105 may be configured to execute workloads 116 and 117 during a training session, and workloads 116 and 117 may be utilized to measure the frequency sensitivity of processor 105. While each of workloads 116 and 117 are being executed by processor 105 during a training session, one or more hardware performance counters may also be monitored and measured. The one or more hardware performance counters may measure data and provide feedback related to the performance and operation of processor 105.

Feedback information from the hardware performance counters may be constructed using a linear or polynomial model of frequency sensitivity. The frequency sensitivity model may be based on performance events and associated metrics. One or more coefficients of the model may be determined empirically by characterizing the actual processing unit during a training session. The procedure to create the model may begin with identifying a plurality of workloads (e.g., workloads 116 and 117) that are representative of all the workloads that are expected to be used on processor 105.

In various embodiments, the performance of the workloads may be measured at a minimum of two clock frequencies. In one embodiment, two frequencies (Freq1 and Freq2) may be chosen that encompass the range of the practical operating frequencies. In one embodiment, the performance value for a given workload at the frequencies, Freq1 and Freq2, may be based on the amount of time it takes for processor 105 to finish a given workload task while running at each of those clock frequencies. In other embodiments, the performance values may be based on other criteria. The performance values may be used to calculate frequency sensitivity values for each workload. The results of the frequency sensitivity calculations for the plurality of workloads may be stored in a first array. The first array (i.e., FrequencySensitivityArray) may be of size N, wherein N is the number of workloads, and the first array may be stored in memory 110 or another memory device.

Average, relevant performance event rates for the same N workloads may be measured using one or more hardware performance counters based on performance events. The relevant performance events may be dependent on the underlying hardware architecture. One performance event metric may be instructions per cycle (IPC). Another metric may be memory controller bandwidth. Other metrics may also be used. For each performance metric, the performance event rates may be stored in a second array (i.e., PerfMetric1Array, PerfMetric2Array) also of size N. The second array may be stored in memory 110 or another memory device. The i^{th} entry in the first array may correspond to the i^{th} entry in the second array.

Computer system 100 will typically have various other devices/components, such as other buses, memory, peripheral devices, etc. For example, as shown, computer system 100 may include an I/O interface 120 which may be coupled to a keyboard 122, display device 124, printer 126, mouse 128, I/O device 130, and/or other devices.

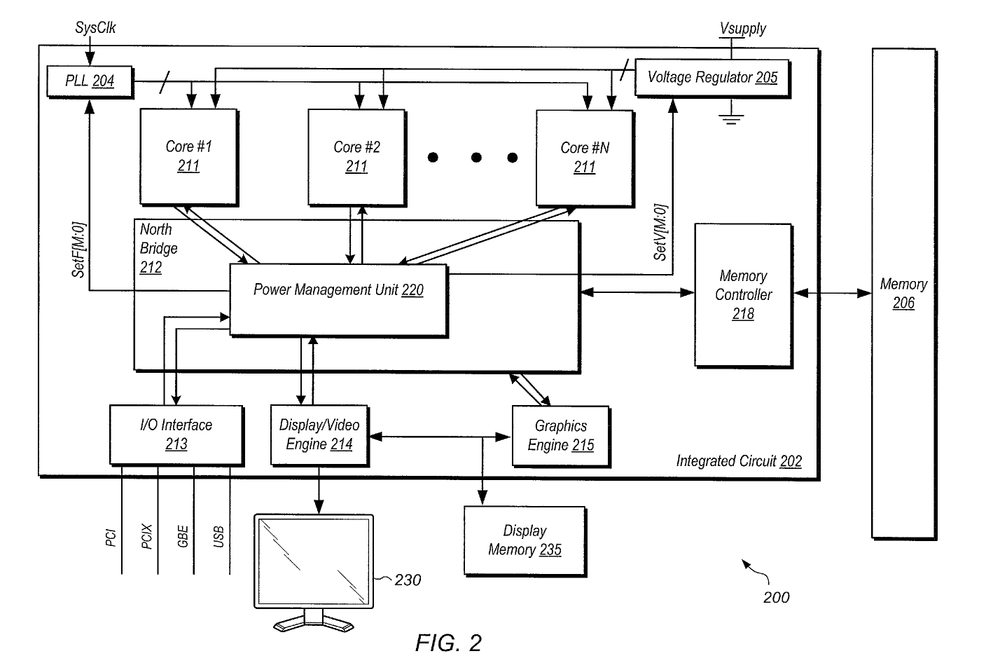

Referring now to FIG. 2, a block diagram of one embodiment of an integrated circuit (IC) coupled to a memory is shown. IC 202 and memory 206, along with display 230 and display memory 235, may form at least a portion of computer system 200. In the embodiment shown, IC 202 is a processor having a number of processing units 211. Processing units 211 are processor cores in this particular example, and are thus also designated as Core #1, Core #2, and so forth. It is noted that the methodology described herein may be applied to other arrangements, such as multi-processor computer systems implementing multiple processors (which may be single-core or multi-core processors) on separate, unique IC dies. Furthermore, embodiments having only a single processing unit 211 are also possible and contemplated.

Each processing unit 211 is coupled to north bridge 212 in the embodiment shown. North bridge 212 may provide a wide variety of interface functions for each of processing units 211, including interfaces to memory and to various peripherals. In addition, north bridge 212 may include a power management unit 220 that is configured to manage an adjustable input clock frequency and adjustable input voltage of each of processing units 211. In other embodiments, power management unit 220 may be located outside of north bridge 212. Furthermore, in multi-core (or multi-processor) embodiments, power management unit 220 may adjust the clock frequencies and voltages of the individual processing units 211 independently of one another. Thus, while a first processing unit 211 may operate at a first clock frequency, a second processing unit 211 may operate at a second clock frequency different than the first, and so on.

In multi-core embodiments, processing units 211 may be identical to each other (i.e., homogenous multi-core), or one or more processing units 211 may be different from others (i.e., heterogeneous multi-core). Processing units 211 may each include one or more execution units, cache memories, schedulers, branch prediction circuits, and so forth. Furthermore, each of processing units 211 may be configured to assert requests for access to memory 206, which may function as the main memory for computer system 200. Such requests may include read requests and/or write requests, and may be initially received from a respective processing unit 211 by north bridge 212. Requests for access to memory 206 may be routed through memory controller 218 in the embodiment shown. Cores 211 may be configured to execute instructions that may be stored in memory 206. Many of these instructions may operate on data that is also stored in the memory 206. It is noted that memory 206 may be physically distributed throughout a computer system and may be accessed by one or more cores 211.

I/O interface 213 is also coupled to north bridge 212 in the embodiment shown. I/O interface 213 may function as a south bridge device in computer system 200. A number of different types of peripheral buses may be coupled to I/O interface 213. In this particular example, the bus types include a peripheral component interconnect (PCI) bus, a PCI-Extended (PCI-X), a gigabit Ethernet (GBE) bus, and a universal serial bus (USB). In various embodiments, many other bus types, such as a PCIE (PCI Express) bus, may also be coupled to I/O interface 213. Peripheral devices may be coupled to some or all of the peripheral buses. Such peripheral devices include (but are not limited to) keyboards, mice, printers, scanners, joysticks or other types of game controllers, media recording devices, external storage devices, network interface cards, and so forth. At least some of the peripheral devices that may be coupled to I/O interface 213 via a corresponding peripheral bus may assert memory access requests using direct memory access (DMA). These requests, which may include read and write requests, may be conveyed to north bridge 212 via I/O interface 213, and may be routed to memory controller 218.

IC 202 also includes a display/video engine 214 that is coupled to display 230 of computer system 200. Display 230 may be a flat-panel LCD (liquid crystal display), plasma display, a CRT (cathode ray tube), or any other suitable display type. Display/video engine 214 may perform various video processing functions and provide the processed information to display 230 for output as visual information. Some video processing functions, such as 3-D processing, processing for video games, and more complex types of graphics processing may be performed by graphics engine 215, with the processed information being relayed to display/video engine 214 via north bridge 212.

Computer system 200 may implement a non-unified memory architecture (NUMA) implementation, wherein video memory and RAM are separate from each other. In the embodiment shown, computer system 200 includes a display memory 235 coupled to display/video engine 214. Thus, instead of receiving video data from memory 206, video data may be accessed by display/video engine 214 from display memory 235. This may in turn allow for greater memory access bandwidth for each of cores 211 and any peripheral devices coupled to I/O interface 213 via one of the peripheral buses.

IC 202 may also include a phase-locked loop (PLL) 204 coupled to receive a system clock signal. PLL 204 may distribute corresponding clock signals to each of processing units 211. The clock signals received by each of processing units 211 may be independent of one another. Furthermore, PLL 204 may be configured to individually control and alter the frequency of each of the clock signals provided to respective ones of processing units 211 independently of one another. The frequency of the clock signal received by any given one of processing units 211 may be increased or decreased in accordance with a calculated frequency sensitivity value for each of processing units 211. The various frequencies at which clock signals may be output from PLL 204 may correspond to different operating points for each of processing units 211. Accordingly, a change of operating point for a particular one of processing units 211 may be put into effect by changing the frequency of its respectively received clock signal.

In various embodiments, changing the respective operating points of one or more processing units 211 may include changing one or more respective clock frequencies. A change in one or more respective clock frequencies may be achieved by power management unit 220 changing the state of digital signals SetF[M:0] provided to PLL 204. Responsive to the change in these signals, PLL 204 may change the clock frequency of the affected processing unit(s).

In the embodiment shown, IC 202 also includes voltage regulator 205. In other embodiments, voltage regulator 205 may be implemented separately from IC 202. Voltage regulator 205 may provide a supply voltage to each of processing units 211. In some embodiments, voltage regulator 205 may provide a supply voltage that is variable according to the supplied clock frequency. In some embodiments, each of processing units 211 may share a voltage plane. Thus, each processing unit 211 in such an embodiment operates at the same voltage as the other ones of processing units 211. In another embodiment, voltage planes are not shared, and thus the supply voltage received by each processing unit 211 may be set and adjusted independently of the respective supply voltages received by other ones of processing units 211. Thus, operating point adjustments that include adjustments of a supply voltage may be selectively applied to each processing unit 211 independently of the others in embodiments having non-shared voltage planes. In the case where changing the operating point includes changing an operating voltage for one or more processing units 211, power management unit 220 may change the state of digital signals SetV[M:0] provided to voltage regulator 205. Responsive to the change in the signals SetV[M:0], voltage regulator 205 may adjust the supply voltage provided to the affected ones of processing units 211.

If a comparison operation indicates that the frequency sensitivity value of a given processing unit 211 is less than a high threshold but greater than a low threshold, then power management unit 220 may enable operating system software (or other software) of the particular processing unit 211 to operate at one of one or more intermediate operating points. In some embodiments, a single intermediate operating point may be implemented. In other embodiments, multiple intermediate operating points may be utilized.

In one embodiment, software executing on integrated circuit 202, such as operating system (OS) software, may select the operating point for each of processing units 211 when the frequency sensitivity value is less than the high threshold and greater than the low threshold. However, comparison operations may continue to be performed by the power management unit for each time interval.

An operating point of a processing unit 211 may be defined by at least a clock frequency, and may also be defined by an operating voltage. Generally speaking, transitioning to a “higher” operating point may be defined as increasing the clock frequency for the affected processing unit 211. Transitioning to a higher operating point may also include increasing the operating voltage of the affected processing unit 211. Similarly, transitioning to a “lower” operating point may be defined by decreasing the clock frequency for the affected processing unit 211. A decrease in the operating voltage provided to an affected processing unit 211 may also be included in the definition of transitioning to a lower operating point.

In one embodiment, the operating points may correspond to performance states (hereinafter ‘P-states’) of the Advanced Configuration and Power Interface (ACPI) specification. Table 1 below lists P-states for one embodiment implemented using the ACPI standard.

TABLE 1

| | | |
|---|---|---|
| P-state index | Frequency | Voltage |

| | | | |
|---|---|---|---|
| P0 | 2 | GHz | 1.1 V |
| P1 | 1.8 | GHz | 1.0 V |
| P2 | 1.5 | GHz | 0.9 V |
| P3 | 1 | GHz | 0.85 V |
| P4 | 800 | MHz | 0.8 V |

The P-states listed in Table 1 above may be applied when an ACPI-compliant processor is operating in a non-idle state known as C0. For an embodiment corresponding to Table 1 above, P-state P0 is the highest operating point, having a clock frequency of 2 GHz and an operating voltage of 1.1 volts. Power management unit 220 in one embodiment may cause a processing unit 211 to operate at P-state P0 responsive to a corresponding frequency sensitivity value exceeding a certain high threshold. The high threshold may take on any of a variety of values, depending on the operating conditions and requirements of the application and processing unit 211. Operation in P-state P0 may be utilized for processing workloads that are compute-bounded (i.e., have a high frequency sensitivity value). A compute-bounded workload may be time sensitive and computationally intensive, requiring infrequent memory accesses. It may be desirable to execute the workload in the shortest time possible to maintain maximum performance while also enabling a quicker return to a P-state commensurate with lower power consumption. Therefore, compute-bounded workloads having a high frequency sensitivity value may be executed in P-state P0, which may enable faster completion.

P-state P4 is the lowest non-idle operating point in this particular embodiment, having a clock frequency of 800 MHz and an operating voltage of 0.8V. Power management unit 220 may cause a processing unit 211 to operating in P-state P4 responsive to a corresponding frequency sensitivity value that is less than a low threshold value. The low threshold may take on any of a variety of values, depending on the operating conditions and requirements of the application and processing unit 211. P-state P4 may be used with memory-bounded workloads as well as with other tasks that are not time-sensitive or frequency-sensitive. Memory-bounded workloads may include frequent accesses to system memory. Since memory accesses involve large latencies (in comparison with the execution times of instructions that do not access memory), reducing the clock frequency for memory-bounded workloads may have a minimal performance impact and with power savings that may improve the performance-per-watt metric of the system.

It is noted that the P-states listed in Table 1 are only one example of a set of operating points. Embodiments that use operating points having different clock frequencies and operating voltages are possible and contemplated. Further, as previously noted above, some embodiments may utilize a shared voltage plane for processing units 211, and thus their respective operating points may be defined on the basis of a clock frequency. In some embodiments, the operating voltage for each of the processing units may either remain fixed, while in other embodiments, the operating voltage may be adjusted for all processing units 211 at the same time.

It should be noted that embodiments are possible and contemplated wherein the various units discussed above are implemented on separate IC's. For example, one embodiment is contemplated wherein cores 211 are implemented on a first IC, north bridge 212 and memory controller 218 are on another IC, while the remaining functional units are on yet another IC. In general, the functional units discussed above may be implemented on as many or as few different ICs as desired, as well as on a single IC. It is also noted that the operating points listed as P-states in Table 1 above may also be utilized with non-ACPI embodiments.

The system, method, and medium disclosed herein may be utilized to adjust an operating point of one or more processing units (e.g., processor cores of a single or multi-core microprocessor, individual stand-alone microprocessors, etc.) based on a calculated real-time frequency sensitivity value. In various embodiments, the operating point of a processing unit may be associated with a specific clock frequency. The processor may be provided with an adjustable input clock frequency signal. An operating voltage (e.g., a supply voltage) provided to the processing unit may also be adjustable. The highest operating point may be defined as an operating point having the highest clock frequency available to a processing unit, and may also be defined as the operating point with the highest operating voltage available to the processing unit. Conversely, the lowest operating point may be defined as the operating point having the lowest operational (e.g., non-zero) clock frequency available to a processing unit, and may be further defined as the operating point with the lowest non-zero operating voltage available. An intermediate operating point may be defined as an operating point in which at least one of the clock frequency and operating voltage are set to respective values between the values which may be otherwise used to define the highest and lowest operating points.

In various embodiments, operating points for each of one or more processing units may be set by a power management unit, by operating system software executing on at least one of the one or more processing units, or by another hardware component or software program. In one embodiment, an operating point of a processing unit may be adjusted depending on whether the processing unit is compute-bounded, memory-bounded, or somewhere in between these two points. Whether the processing unit is compute-bounded, memory-bounded, or somewhere in between may be determined based on a frequency sensitivity value calculated in real-time. A compute-bounded workload may be defined as a processing workload that is computationally intensive, with infrequent accesses to main memory. Completion of a compute-bounded workload in the shortest amount of time possible may require that the processing unit(s) executing the workload operate at a highest available clock frequency while maximizing the number of instructions executed per cycle. Accordingly, the system, method, and medium described herein may be enabled to determine when a compute-bounded workload is executing, and further to increase the operating point (i.e., increase the clock frequency and/or operating voltage) to a high-performance state responsive thereto. In one embodiment, the system, method, and medium may cause the processing unit to operate at an operating point corresponding to the highest performance state available for that particular node responsive to detecting a compute-bounded workload, corresponding to a high frequency sensitivity value.

The system, method, and medium described herein may be configured to reduce the clock frequency in response to calculating a low frequency sensitivity value for a processor executing an application, such as a memory-bounded workload. Reducing the clock frequency may also entail reducing the operating voltage. Decreasing the operating point to a low-performance state when executing a memory-bounded workload may result in power savings without adversely impacting performance. In one embodiment, the system, method, and medium may cause a processing unit to operate at an operating point corresponding to a lowest non-idle performance state responsive to detecting a memory-bounded workload. The lowest non-idle operating point may be defined herein as an operating point in which a processing unit is receiving power and a clock signal at a non-zero frequency.

The frequency sensitivity value of a workload application executing on each processing unit may be calculated by a power management unit, other hardware or software component, or operating system on a regularly scheduled basis. The calculation may be performed on a fixed interval basis. The fixed interval may be any of a variety of sizes of intervals. In various embodiments, the interval on which the calculation may be performed may be on the order of microseconds, and the interval may be adjustable based on the detection of one or more events. The system, method, and medium disclosed herein may allow for fine-grained operating point control in comparison to that provided by traditional operating system software, in which the time intervals for monitoring, comparing, and setting the operating point can range between 30 and 100 milliseconds. In some embodiments, the calculation of the frequency sensitivity and the adjustment of the clock frequency may be performed without requiring interrupts or other overhead that may be required by the operating system software.

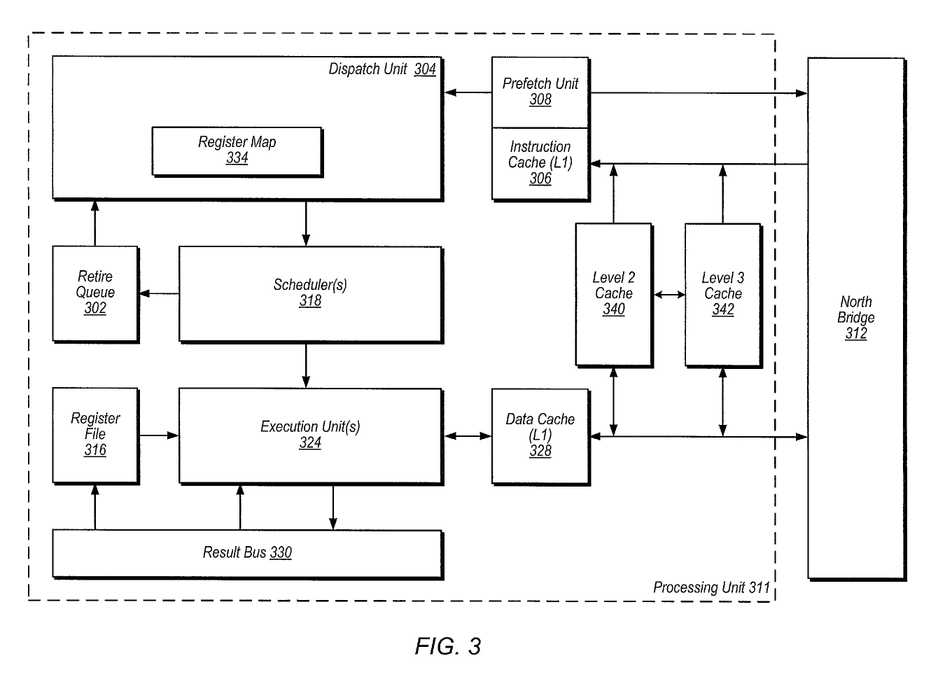

Turning now to FIG. 3, a block diagram of one embodiment of a processing unit is shown. Processing unit 311 may include a level one (L1) instruction cache 306 and an L1 data cache 328. The processing unit 311 may also include a prefetch unit 308 coupled to the instruction cache 306. A dispatch unit 304 may be configured to receive instructions from the instruction cache 306 and to dispatch operations to the scheduler(s) 318. One or more of the schedulers 318 may be coupled to receive dispatched operations from the dispatch unit 304 and to issue operations to the one or more execution unit(s) 324. The execution unit(s) 324 may include one or more integer units, one or more floating point units, one or more load/store units, and/or one or more other units. Results generated by the execution unit(s) 324 may be output to one or more result buses 330 (a single result bus is shown here for clarity, although multiple result buses are possible and contemplated). These results may be used as operand values for subsequently issued instructions and/or stored to the register file 316. A retire queue 302 may be coupled to the scheduler(s) 318 and the dispatch unit 304. The retire queue 302 may be configured to determine when each issued operation may be retired. Note that processing unit 311 may also include many other components. For example, the processing unit 311 may include a branch prediction unit (not shown) configured to predict branches in executing instruction threads.

The instruction cache 306 may store instructions for fetch by the dispatch unit 304. Instruction code may be provided to the instruction cache 306 for storage by prefetching code from system memory (not shown) through prefetch unit 308. Instruction cache 306 may be implemented in various configurations (e.g., set-associative, fully-associative, or direct-mapped).

Processing unit 311 may also include a level two (L2) cache 340. Whereas instruction cache 306 may be used to store instructions and data cache 328 may be used to store data (e.g., operands), L2 cache 340 may be a unified cache used to store instructions and data. Level three (L3) cache 342 may also be a unified cache used to store instructions and data. Although not shown here, some embodiments may also include a level four (L4) cache. In general, the number of cache levels may vary from one embodiment to the next.

The prefetch unit 308 may prefetch instruction code from system memory via north bridge 312 for storage within instruction cache 306. The prefetch unit 308 may employ a variety of specific code prefetching techniques and algorithms. The dispatch unit 304 may output operations executable by the execution unit(s) 324 as well as operand address information, immediate data and/or displacement data. In some embodiments, the dispatch unit 304 may include decoding circuitry (not shown) for decoding certain instructions into operations executable within the execution unit(s) 324. Simple instructions may correspond to a single operation. In some embodiments, more complex instructions may correspond to multiple operations. Upon decode of an operation that involves the update of a register, a register location within register file 316 may be reserved to store speculative register states. In an alternative embodiment, a reorder buffer may be used to store one or more speculative register states for each register and the register file 316 may store a committed register state for each register. A register map 334 may translate logical register names of source and destination operands to physical register numbers in order to facilitate register renaming. The register map 334 may track which registers within the register file 316 are currently allocated and unallocated.

Processing unit 311 may support out of order execution. The retire queue 302 may keep track of the original program sequence for register read and write operations, allow for speculative instruction execution and branch misprediction recovery, and facilitate precise exceptions. In some embodiments, the retire queue 302 may also support register renaming by providing data value storage for speculative register states (e.g., similar to a reorder buffer). In other embodiments, the retire queue 302 may function similarly to a reorder buffer but may not provide any data value storage. As operations are retired, the retire queue 302 may deallocate registers in the register file 316 that are no longer needed to store speculative register states and provide signals to the register map 334 indicating which registers are currently free. By maintaining speculative register states within the register file 316, (or, in alternative embodiments, within a reorder buffer) until the operations that generated those states are validated, the results of speculatively-executed operations along a mispredicted path may be invalidated in the register file 316 if a branch prediction is incorrect.

In one embodiment, a given register of register file 316 may be configured to store a data result of an executed instruction and may also store one or more flag bits that may be updated by the executed instruction. Flag bits may convey various types of information that may be important in executing subsequent instructions (e.g., indicating a carry or overflow situation exists as a result of an addition or multiplication operation). Architecturally, a flags register may be defined that stores the flags. Thus, a write to the given register may update both a logical register and the flags register. It should be noted that not all instructions may update the one or more flags.

The register map 334 may assign a physical register to a particular logical register (e.g., architected register or micro-architecturally specified registers) specified as a destination operand for an operation. The dispatch unit 304 may determine that the register file 316 has a previously allocated physical register assigned to a logical register specified as a source operand in a given operation. The register map 334 may provide a tag for the physical register most recently assigned to that logical register. This tag may be used to access the operand's data value in the register file 316 or to receive the data value via result forwarding on the result bus 330. If the operand corresponds to a memory location, the operand value may be provided on the result bus (for result forwarding and/or storage in the register file 316) through a load/store unit (not shown). Operand data values may be provided to the execution unit(s) 324 when the operation is issued by one of the scheduler(s) 318. Note that in alternative embodiments, operand values may be provided to a corresponding scheduler 318 when an operation is dispatched (instead of being provided to a corresponding execution unit 324 when the operation is issued).

As used herein, a scheduler is a device that detects when operations are ready for execution and issues ready operations to one or more execution units. For example, a reservation station may be one type of scheduler. Independent reservation stations per execution unit may be provided, or a central reservation station from which operations are issued may be provided. In other embodiments, a central scheduler which retains the operations until retirement may be used. Each scheduler 318 may be capable of holding operation information (e.g., the operation as well as operand values, operand tags, and/or immediate data) for several pending operations awaiting issue to an execution unit 324. In some embodiments, each scheduler 318 may not provide operand value storage. Instead, each scheduler 318 may monitor issued operations and results available in the register file 316 in order to determine when operand values will be available to be read by the execution unit(s) 324 (from the register file 316 or the result bus 330).

Although not explicitly shown here, a number of different communications paths may be provided between the various units of processing unit 311 (including units not explicitly shown) and a power management unit, such as power management unit 220 (of FIG. 2). More particularly, processing unit 311 may utilize such communications paths in order to provide information indicating a performance metric or the value of a hardware performance counter to a power management unit, to the operating system (OS) running on the processing unit, or to high-level software running on the processing unit. In other embodiments, the information may be provided elsewhere, depending on the given system configuration.

In various embodiments, there may be a hardware performance counter associated with retirement queue 302, and the hardware performance counter may provide information regarding instruction retirements to a power management unit. In various embodiments, execution unit(s) 324 may provide information concerning executed instructions, dispatch unit 304 may provide information concerning dispatched instructions, scheduler(s) 318 may provide information concerning scheduled instructions, and any one (or all) of the various caches may provide information regarding cache hits or misses. Also, execution unit(s) 324 may provide an instructions per cycle (IPC) value and a memory controller, such as memory controller 218 (of FIG. 2) may provide a memory controller bandwidth value. Additionally, a branch prediction unit (not shown) may provide information regarding branch mispredictions. Other units not shown in FIG. 3 may also provide other types of information to a power management unit or operating system software. The information received from the various units of processing unit 311 may be used to increment a plurality of hardware performance counters.

The hardware performance counters may reside in any of various locations. In various embodiments, one or more of the hardware performance counters may reside with the actual units being monitored. In various embodiments, one or more of the hardware performance counters may reside within a power management unit. In other embodiments, one or more of the hardware performance counters may be part of a performance monitoring unit (not shown). In various embodiments, the performance monitoring unit may be incorporated in or coupled to another unit, such as a power management unit. In various embodiments, the various hardware performance counters may be considered or referred to as a performance monitoring unit.

The measurements obtained by these hardware performance counters may be used to create the frequency sensitivity feedback model during the characterization stage and to determine the value of various metrics during run-time (the run-time stage). Creating the frequency sensitivity feedback model may involve calculating one or more coefficients. The coefficients may then be used to provide different weights to the various metrics during run-time when the real-time frequency sensitivity value of an application is calculated.

In the characterization stage, various methods of matching the hardware metrics to the frequency sensitivity values of the various workloads may be applied. The various methods may involve weighing certain types of information more than other types. In addition, some types of information may be disregarded altogether at run-time. The values of hardware performance counters may be used to calculate a frequency sensitivity value, which may be used to adjust the input clock frequency for processing unit 311.

A processing unit 311 upon which a low frequency sensitivity score is detected may be placed in a lowest possible non-idle operating point with little negative impact on overall processing unit performance. The lowest non-idle operating point may be defined as one having a lowest clock frequency. The lowest possible operating point may also be defined by one having a lowest possible operating voltage. Using the example of Table 1 above, when a processing unit 311 is determined to have a frequency sensitivity value below a certain low threshold during a given time interval, it may be placed in P-state P4 for at least the next time interval.

When a high frequency sensitivity value is calculated for a given processing unit 311 during a time interval, the highest operating point may be selected for that node for at least the next time interval. Using the example of Table 1 above, computing a high frequency sensitivity value may result in processing unit 311 being placed into the P0 state.

When the calculated frequency sensitivity value for a given time interval is above the low threshold but less than the high threshold, the corresponding processing unit may be placed at an intermediate operating point requested by an operating system, other software, firmware, or other hardware. P-states P1, P2, and P3 from Table 1 are examples of intermediate operating points that may be utilized by a processing unit. A power management unit may conduct comparisons of frequency sensitivity values to the low and high thresholds, and may override the operating point selection by shifting the affected processing unit 311 to the highest or lowest operating point any time a corresponding frequency sensitivity value is computed.

Hysteresis threshold levels may also be utilized with the high and low thresholds when determining whether or not to change the clock frequency of a processing unit. A high hysteresis threshold may be considered when determining whether to transition into or out of the highest operating point, while a low hysteresis threshold may be considered when determining whether to transition into or out of the lowest operating point. Utilizing hysteresis thresholds may prevent the transitioning to a non-optimal operating point due to an anomaly. For example, consider a situation when a compute-bounded workload (i.e., highly frequency sensitive application) is executing in P-state P0. A branch misprediction in this situation may cause a pipeline stall, thereby causing a momentary decrease in the frequency sensitivity value. The high hysteresis threshold level may be factored in for such a situation, thereby enabling the corresponding processing unit 311 to remain operating in P-state P0.

The operations described above may enhance the efficiency of a processor by improving its performance per watt of power consumed. Reducing the clock frequency and operating voltage to their lowest possible operational values for the least frequency sensitive and/or memory-bounded applications may in turn allow those applications to still execute in a timely manner without wasting power that is otherwise unneeded. Increasing the clock frequency and operating voltage to their highest possible operational values for those applications that are the most frequency sensitive and/or compute-bounded applications may allow those applications to execute faster at the desired performance levels and thus enable upon completion a quicker return to an operating point with lower power consumption. A processor with a high frequency sensitivity score may benefit from an increase in the input clock frequency, such that an increase in frequency produces a proportional increase in the performance of the processor.

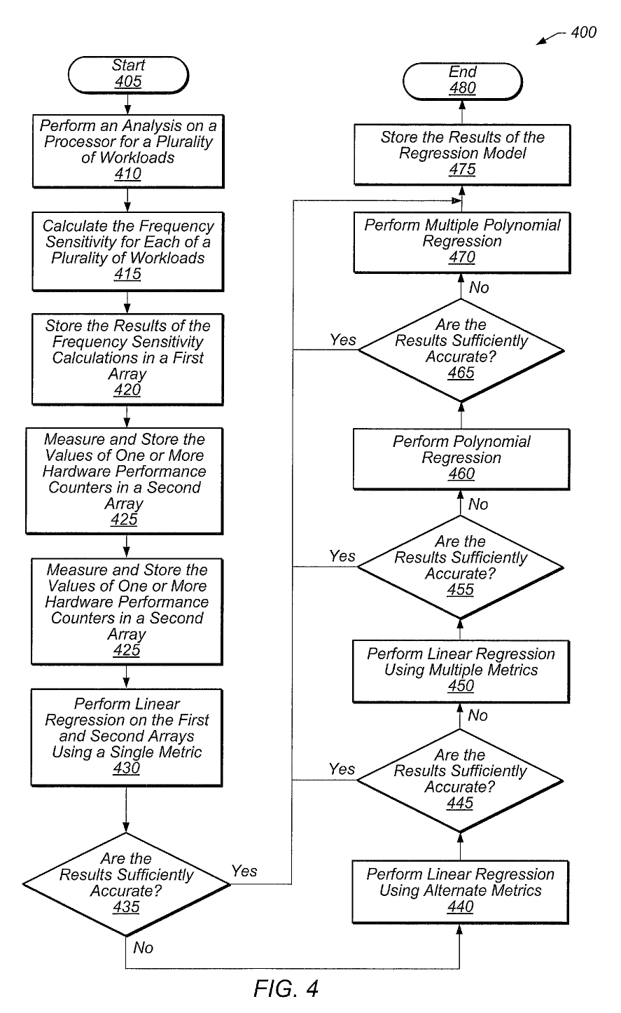

Turning now to FIG. 4, one embodiment of a method for creating a model of the frequency sensitivity of a processing unit is shown. For purposes of discussion, the steps in this embodiment are shown in sequential order. It should be noted that in various embodiments of the method described below, one or more of the elements described may be performed concurrently, in a different order than shown, or may be omitted entirely. Other additional elements may also be performed as desired.

The method 400 starts in block 405, and then in block 410, an analysis may be performed on a processor for one or more workloads. The plurality of workloads may include one or more pre-defined, benchmark workloads. These benchmark workloads may be used in one or more training sessions to measure the performance of a variety of processors, cores, architectures, systems, etc. The one or more workloads may include a variety of workloads which represent the variety of applications that a given core processor may be likely to execute in a typical run-time environment. As part of the analysis, the frequency sensitivity at one or more input clock frequencies may be calculated for each of the plurality of workloads (block 415).

In one embodiment, the performance of a pre-defined workload ‘i’ may be calculated at two clock frequencies (Freq1 and Freq2, where Freq1 is greater than Freq2), and then the frequency sensitivity may be calculated based on the performance calculations, according to the following formula:

$$\begin{matrix}FrequencySensitivity \\ of {Workload}_{i}\end{matrix} = \frac{\frac{( {PerformanceFreq}_{1}}{{PerformanceFreq}_{2} )}}{( {Freq}_{1} / {Freq}_{2} )}$$

In other embodiments, the frequency sensitivity may be calculated using other formulas. For example, the frequency sensitivity may be calculated with the Freq1 and Freq2 terms reversed, such that a larger frequency sensitivity value represents less performance gain for an increase in frequency, and a smaller frequency sensitivity value represents more performance gain for an increase in frequency. Other formulas for calculating frequency sensitivity value may be utilized.

In various embodiments, the performance of a pre-defined workload may be calculated at more than two frequencies. For example, in one embodiment, the performance of a workload may be calculated at four different input clock frequencies. The frequency sensitivity may be calculated for the three different frequency intervals between the four input clock frequencies. Thus, when the frequency sensitivity is calculated in real-time by a processor, the processor may utilize a model specific to the particular interval of the frequency spectrum corresponding to the current input clock frequency when making a decision on whether or not to make a frequency adjustment. In various embodiments, the frequency sensitivity of a processor may be linear over the entire input clock frequency range, and only two frequencies may need to be utilized during the training session. In other embodiments, the frequency sensitivity of a processor may be non-linear over the entire input clock frequency range, and more than two frequencies may be utilized during the training session.

As part of determining the frequency sensitivity of a given processor, the performance of the processor while executing one or more benchmark workloads may be measured. The performance of the processor may be given a score or value, and the performance score may be based on the time it takes for a workload to be completed. For example, in one embodiment, the performance score may be based on the inverse of the time it takes for a workload to finish execution. For example, a first workload may take 0.1 seconds to complete at a first frequency and 0.05 seconds to complete at a second frequency. Therefore, the performance score may be calculated as (1÷0.1 seconds) or 10 for the first frequency, and the performance score may be calculated as (1÷0.05 seconds) or 20 for the second frequency. The performance may be based on how efficient or quickly a core completes an application.

If the second frequency is twice the first frequency, then the frequency sensitivity for this workload and this processor may be 1. In one embodiment, a high frequency sensitivity value for a processor may indicate that the processor would realize a significant benefit from an increase in input clock frequency, and a low frequency sensitivity value for a processor may indicate that the processor would realize a negligible benefit from an increase in input clock frequency. In other embodiments, the indications may be reversed, such that a high frequency sensitivity value would indicate that the processor would realize a negligible benefit from an increase in input clock frequency, and a low frequency sensitivity value for a processor may indicate that the processor would realize a significant benefit from an increase in input clock frequency. The range of values that a frequency sensitivity value may take may vary from embodiment to embodiment. For example, in one embodiment, the frequency sensitivity value may range from 0 to 1, whereas in another embodiment, the frequency sensitivity value may range from 1 to 100.

The results of the frequency sensitivity calculations may be stored in a first array (block 420). The first array may be stored in any of various storage devices, depending on the particular architecture of the system and/or processor. Other types of calculations and formulas may be used, with other factors or other adjustments to either the performance score or the frequency sensitivity score.

While characterizing a processor, measurements other than frequency sensitivity and performance may also be taken. While each of the plurality of benchmark workloads is executing, one or more hardware performance counters may be monitored, and the values of the counters may be stored for each of the workloads (block 425). The hardware performance counter measurements may be stored in a storage device, such as a cache, system memory, dynamic random-access memory (DRAM), and/or another location or storage device. In various embodiments, the counters may be measured over a fixed interval, and the interval may be the same for each of the counters and each of the plurality of workloads. In other embodiments, variable sizes of intervals may be utilized.

In one embodiment, the hardware performance counters may be measured for each workload at a single clock frequency. Any of the plurality of input clock frequencies may be utilized when taking the measurements, as the values of each of the hardware performance counters may be linear over the range of input clock frequencies. In other cases, the values of one or more of the hardware performance counters may be non-linear over the range of input clock frequencies. In various embodiments, the values of the metrics may be calculated for each of the workloads for one or more of the plurality of frequencies to which the input clock of the processor may be set.

After the hardware performance counters have been measured and stored, linear regression may be performed on the two arrays, with the second array (hardware performance counters) serving as the input array and the first array (training session frequency sensitivity values) serving as the target array. In a first step, a single metric may be used to perform the linear regression on the two arrays (block 430). In one embodiment, the single metric may be IPC. In other embodiments, any of the other metrics may be used. If the first step of linear regression does not produce sufficiently accurate results (conditional block 435), a second step of linear regression using alternate metrics may be implemented (block 440). Each step of linear regression may utilize a least squares method to minimize the sum of the squares of the errors between the stored frequency sensitivity values and the values from the regression-based formula. The least squares method is well known to those skilled in the art.

Each of the one or more metrics may be used during this second step of linear regression, and the metric with the most accurate results may be selected. For example, the second step of linear regression may result in a model of the following form:

FrequencySensitivity=M*Metricᵢ+C

The value ‘M’ may be a linear scaling coefficient, and the value ‘C’ may be an offset value. The value ‘Metricᵢ’ may be the metric that produces the most accurate results for the model. An attempt may be made to create the above equation with each of the one or more metrics, and the metric that generates the most accurate results may be selected. In one embodiment, the accuracy of the results may be measured using the sum of squares of the deviations from each data point of the model based on the second array (i.e., M*Metricᵢ+C) to the first array (i.e., FrequencySensitivity).

If linear regression using alternate metrics does not produce sufficiently accurate results (conditional block 445), a third step of linear regression using multiple metrics (i.e., multiple linear regression) may be executed (block 450). The third step of multiple linear regression may result in a model of the following form:

FrequencySensitivity=M₁*Metric₁+M₂*Metric₂+M₃*Metric₃+C

The values ‘M1’, ‘M2’, and ‘M3’ may be linear scaling coefficients and the value ‘C’ may be an offset value. The value ‘Metric₁’ may be any of the one or more metrics, ‘Metric₂’ may be any of the other one or more metrics, and so on. In other embodiments, more than three metrics may be used to create a frequency sensitivity model.

If the third step of multiple linear regression does not produce sufficiently accurate results (conditional block 455), a fourth step of polynomial regression may be executed (block 460). Polynomial regression may include utilizing different polynomial models to match the metric values to the frequency sensitivity values. For example, in one embodiment, the fourth step of polynomial regression may result in a model of the following form:

FrequencySensitivity=M₁*(Metric₁)̂2+M₂*(Metric₂)̂3+M₃*Metric₃*Metric₄+C

In other embodiments, the above model may include more or fewer terms. A first polynomial model form may be attempted, and if sufficiently accurate results are not produced, then a second model may be attempted, and so on. In one embodiment, potential polynomial forms may be attempted based on knowledge of the underlying processor architecture and how the various metrics relate to the performance and frequency sensitivity of the processor. For example, some metrics, such as IPC, may typically scale more with frequency sensitivity. Other metrics, such as memory controller bandwidth, may have a negative relationship to frequency sensitivity, such that an increase in memory controller bandwidth may result in a decrease in the frequency sensitivity value. Additionally, if multiple cores are operating and overloading the memory bus, a squared metric, cubed metric, or other metric term may model the resultant nonlinear behavior. In other embodiments, successive polynomial forms may be randomly selected and calculated until sufficiently accurate results are obtained.

If the results are sufficiently accurate (conditional block 465), then the results of the regression model may be stored (block 475). If the results are not sufficiently accurate (conditional block 465), then multiple polynomial regression may be performed (block 470). Performing multiple polynomial regression may include trying other higher order regression models. After sufficiently accurate results are obtained, the results of the regression model may be stored (block 475). The results of the model may include a specific formula and one or more coefficients. The specific formula may be one of the formulas described above or a variation or combination of the aforementioned formulas. After block 475, the method 400 may end in block 480.

The overall linear regression process may proceed by starting with a simple model and gradually increasing the complexity of the model to obtain more accurate results. The advantage of finding a simple regression model to match the metric values to the frequency sensitivity values is that it may result in a straightforward implementation for the processor to implement during run-time of an actual application. A power management unit, processor, or other unit may use the resultant model to calculate the frequency sensitivity at regular intervals, and a simple formula with a limited number of metrics may be less of a processing burden than a more complicated formula with many metrics.

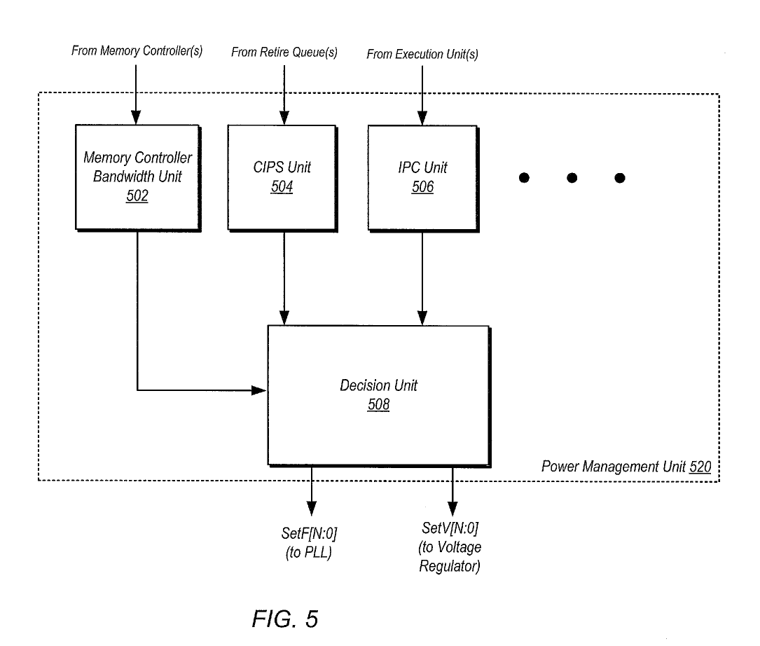

Turning now to FIG. 5, a block diagram illustrating one embodiment of a power management unit is shown. Power management unit 520 may be configured to monitor one or more processing units (not shown) using memory controller bandwidth unit 502, committed instructions per second (CIPS) unit 504, and instructions-per-cycle (IPC) unit 506. Units 502-506 are representative of any number of hardware performance counters which may provide information to decision unit 508 regarding one or more processing units. In other embodiments, units 502-506 may reside in locations outside of power management unit 520. Decision unit 508 may consider information provided from one or more of units 502-506 when determining whether or not to adjust the clock frequency for each of one or more plurality of processing units. In various embodiments, decision unit 508 may adjust the clock frequency to an optimum frequency for maximizing performance per watt of the processing unit. The optimum frequency may be determined based on the real-time frequency sensitivity value and additional information, such as a power number associated with a particular performance state of the processing unit. Alternatively, decision unit 508 may adjust the clock frequency to maximize the square of the performance per watt. In other embodiments, decision unit 508 may adjust the clock frequency to maximize other parameters.

Generally speaking, power management unit 520 may monitor the activity level of one or more processing units. Power management unit 520 may monitor conditions and/or events of the various components of each processing unit. For example, power management unit 520 may include memory controller bandwidth unit 502, CIPS unit 504, and IPC unit 506 for monitoring the conditions and events of each processing unit. Memory controller bandwidth unit 502 may monitor the bandwidth of one or more memory controllers (not shown). CIPS unit 504 may monitor the committed instructions per second of one or more units. IPC unit 506 may include an instruction counter (not shown) that may be coupled to receive indications of executed instructions from each of a number of processing/execution units. The instruction counter may track a count of the instructions executed for each of one or more processing units. The count tracked for each processing unit may be provided as a count value to decision unit 508.

Clock frequency adjustments for each of the one or more processing units by decision unit 508 may be effected through changes to the states of signals SetF[N:0], wherein N may be any number of signals. Changes to the frequency of a clock signal of a given processing unit may also include changing a respective supply voltage. Supply voltage adjustments for each of the processing units may be effected through changes to the states of signals SetV[N:0]. Decision unit 508 may also make thread scheduling decisions based on the calculated frequency sensitivity value of a given processing unit. Decision unit 508 may decide to start additional threads on a processing unit that is not scaling with frequency. Also, if decision unit 508 determines a processing unit is memory bound, then it may start additional memory-intensive threads on another die that has a separate memory controller.

Other configurations and architectures of power management unit 520 are possible and are contemplated. In various embodiments, power management unit 520 may include other components not shown in FIG. 5. In various embodiments, power management unit 520 may not include one or more of the components shown in FIG. 5.

Generally speaking, power management unit 520 may be implemented in any configuration in which the hardware performance counters of one or more processing units may be monitored and which may effect a change of clock frequency accordingly. In various embodiments, a frequency sensitivity value of one or more processing units may be compared to one or more thresholds or levels for each of a plurality of time intervals, and respective input clock frequencies for a next succeeding time interval may be selected according to the results of the comparisons. Each real-time frequency sensitivity value may represent a ratio of how the performance of each processing unit scales in relationship to the frequency of the input clock. The real-time frequency sensitivity value may also represent how a given processing unit may benefit from an increase in the input clock frequency. In various embodiments, a frequency sensitivity value of one or more processing units may be utilized to reference a table. The table may provide a mapping of frequency sensitivity values to actions that may be taken in regard to adjusting the input clock frequency.

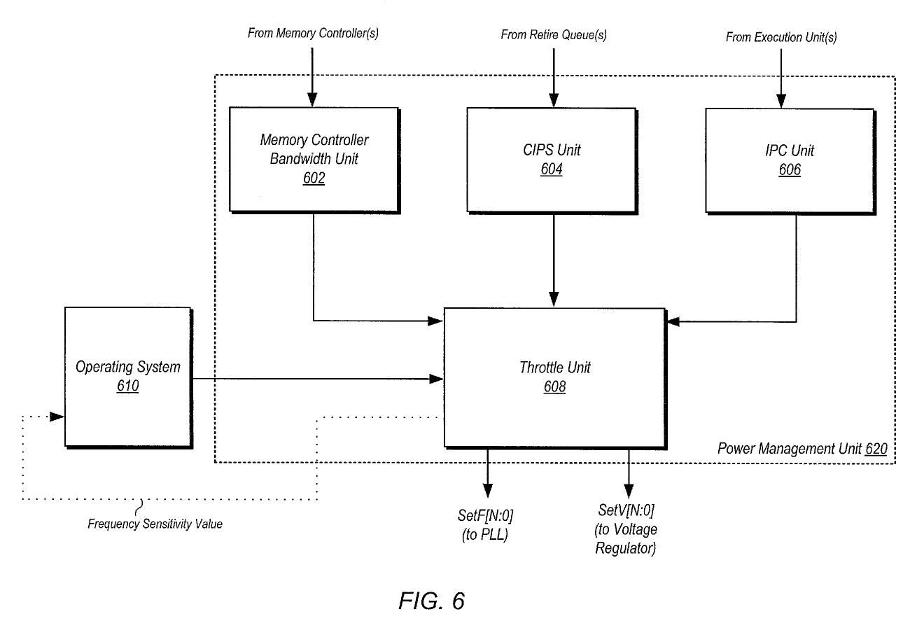

Turning now to FIG. 6, a block diagram illustrating another embodiment of a power management unit is shown. Power management unit 620 may include throttle unit 608, and throttle unit 608 may be coupled to memory controller bandwidth unit 602, committed instructions per second (CIPS) unit 604, and instructions per cycle (IPC) unit 606. Throttle unit 608 may also be coupled to operating system (OS) 610, and OS 610 may be executing on one of the processing units (not shown) coupled to power management unit 620.

In various embodiments, OS 610 may make a determination regarding the operating point for each of the one or more processing units of the corresponding computer system. OS 610 may make decisions based on an activity level of the one or more processing units. OS 610 may convey requests for adjustments of the operating point(s) to throttle unit 608. An adjustment to an operating point may include adjusting a clock frequency and/or a source voltage. Throttle unit 608 may calculate the real-time frequency sensitivity value of the one or more processing units using information obtained from units 602-606. In other embodiments, additional hardware performance counters may be utilized by throttle unit 608 for performing the frequency sensitivity calculations. After receiving the requested adjustments to the operating point(s) from OS 610, throttle unit 608 may decide to accept or reject those adjustments based on the calculated frequency sensitivity value for each of the one or more processing units. In various embodiments, throttle unit 608 may function as a restraint on OS 610 in regard to setting the operating point of the various processing units by determining whether to comply with a given request.

In various embodiments, the frequency sensitivity value may be conveyed from the throttle unit 608 to OS 610. Alternatively, OS 610 may calculate the frequency sensitivity value or receive the frequency sensitivity value from another source. OS 610 may utilize the frequency sensitivity value when making frequency change requests, such that the determination regarding the operating point may be based on the frequency sensitivity value.

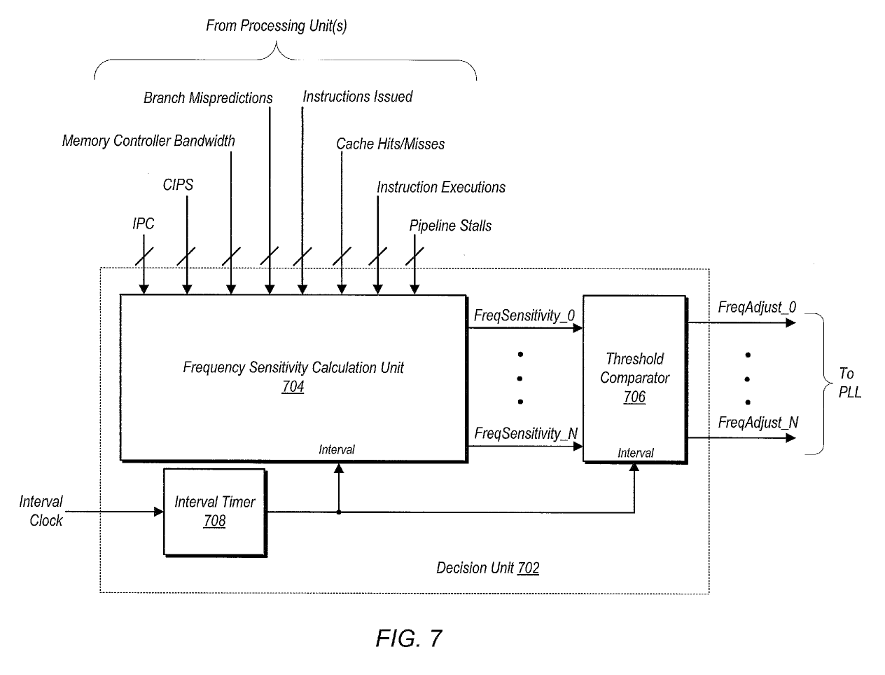

Turning now to FIG. 7, a block diagram illustrating one embodiment of a decision unit is shown. Decision unit 702 may include a frequency sensitivity calculation unit 704, a threshold comparator 706, and an interval timer 708. In other embodiments, decision unit 702 may include various other components. In various embodiments, a throttle unit, such as throttle unit 608 (of FIG. 6), may perform the functions described as being performed by decision unit.

In one embodiment, frequency sensitivity calculation unit 704 may be configured to calculate a frequency sensitivity value for one or more processing units (not shown). In various embodiments, frequency sensitivity calculation unit 704 may be configured to calculate and track a moving average of frequency sensitivity for one or more processing units, and to compare the average frequency sensitivity value with one or more thresholds. The results of the comparison may be used to determine the appropriate operating point for a corresponding processing unit. Comparisons may be conducted on an interval basis, and interval timer 708 may determine the setting of intervals.

Frequency sensitivity calculation unit 704 may determine the frequency sensitivity for each processing unit coupled thereto based on one or more metrics. For example, frequency sensitivity calculation unit 704 may be coupled to receive count values generated from various hardware performance counters, including IPC, CIPS, memory controller bandwidth, branch mispredictions, instructions issued, cache hits and misses, instruction executions, pipeline stalls, and/or one or more other metrics. Cache hits and misses may be counted for one or more caches (e.g., L1 cache, L2 cache, L3 cache) corresponding to one or more processing units.

One or more coefficients may be applied to the metrics, such that some of the metrics may be given a greater weight than others. In various embodiments, a polynomial formula utilizing one or more metrics may be used to calculate the frequency sensitivity values. In various embodiments, each of the hardware performance counters may be reset at the end of an interval as indicated by the assertion of the output signal from interval timer 708.

The real-time frequency sensitivity value calculated and tracked by frequency sensitivity calculation unit 704 may be determined based on a previously created formula. The formula may be based on any one of the metrics, an aggregate of two or more of the metrics, or a combination of all of the metrics. For example, frequency sensitivity calculation unit 704 may determine that a processor workload has a low real-time frequency sensitivity value (i.e., is memory-bounded) based both on cache misses and pipeline stalls, both of which may occur frequently in applications requiring a large number of memory accesses. In another example, a high number of instruction executions with few cache accesses, determined by a total number of cache hits and misses, may result in a high frequency sensitivity value (i.e., indicate a compute-bounded workload).

In various embodiments, frequency sensitivity calculation unit 704 may determine an average frequency sensitivity value for each processing unit based on information received during a present time interval as well as historical information. In the embodiment shown, averages may be determined responsive to the output interval timer 708. Interval timer 708 may be coupled to receive an interval clock signal, and may assert an interval output signal after a certain number of cycles of this clock signal have been received.

The real-time frequency sensitivity value for each processing unit (i.e., FreqSensitivity_0, FreqSensitivity_N) may be provided from frequency sensitivity calculation unit 704 to threshold comparator 706. Threshold comparator 706 may conduct comparisons of the received real-time frequency sensitivity values to one or more thresholds responsive to the output of interval timer 708. A delay time may be allowed to enable frequency sensitivity calculation unit 704 to determine and provide the frequency sensitivity results, with threshold comparator 706 conducting the comparisons after the delay time has elapsed. The threshold comparison results (i.e., FreqAdjust_0, FreqAdjust_N) may be provided from threshold comparator 706 to a PLL (not shown), which may then cause adjustments to the clock frequencies of the corresponding processing units. These operations may be repeated for each time interval as timed by interval timer 708.

Frequency sensitivity calculation unit 704 may be a hardware and/or software based implementation. In one embodiment, a dedicated hardware circuit may be utilized to calculate the frequency sensitivity. In another embodiment, a software program or routine executing on a processor core may calculate the frequency sensitivity. In various embodiments, coefficients may be stored in system memory and loaded into cache memory during run-time. In a further embodiment, a combination of a dedicated hardware circuit and a software program may be utilized to calculate the frequency sensitivity.

Based on the calculated real-time frequency sensitivity score for a particular processor core, a decision may be made to adjust the clock frequency for that particular processor core. For example, if the real-time frequency sensitivity score is above a first high threshold as determined by threshold comparator 706, the frequency may be increased for the core. If the real-time frequency sensitivity score is below a second low threshold, the frequency may be decreased for the core. If the real-time frequency sensitivity score is in between the first and second thresholds, then the current frequency may be maintained. Other types of adjustment schemes may be used to modify the clock frequency based on the frequency sensitivity score.

In various embodiments, decision unit 702 may adjust the clock frequency to an optimum frequency for maximizing performance per watt when the real-time frequency sensitivity value is within a certain range. For example, if the real-time frequency sensitivity score is in between the first and second thresholds, decision unit 702 may adjust the input clock frequency to the optimum frequency for maximizing performance per watt. Other variations of clock frequency adjustment schemes are possible and are contemplated.

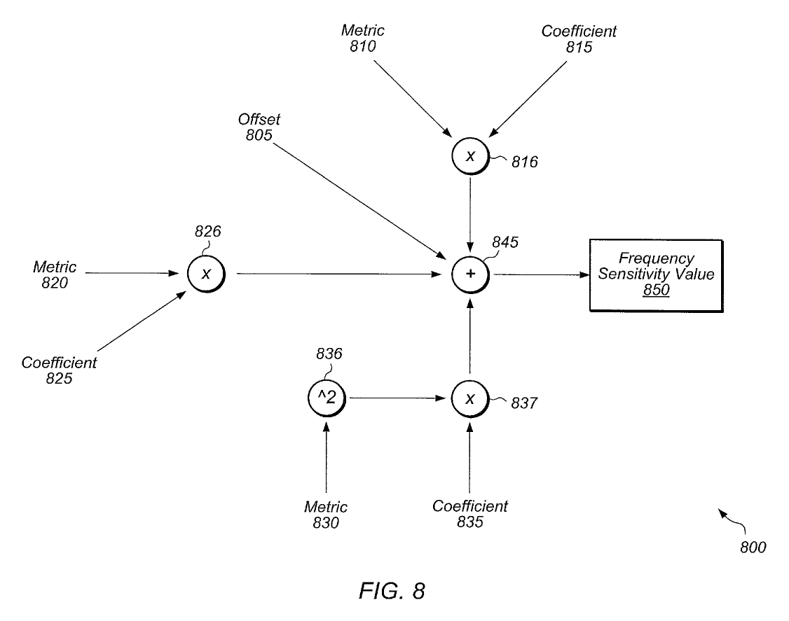

Referring now to FIG. 8, one embodiment of a frequency sensitivity calculation unit is shown. Frequency sensitivity calculation unit 800 may include dedicated hardware circuits for performing a variety of arithmetic functions on metric values and coefficient values. Metrics 810, 820, and 830 are representative of any number of metric values which may be used to calculate the frequency sensitivity of a processing unit. Metric 810 may correspond to a first hardware performance counter (e.g., IPC, CIPS, memory controller bandwidth), metric 820 may correspond to a second hardware performance counter, and so on. Coefficients 815, 825, and 835 may have been calculated using linear or polynomial regression in a previous step using information obtained during a training session of the one or more processing units.

As shown in FIG. 8, metric 810 may be multiplied by coefficient 815 in multiplier 816 and metric 820 may be multiplied by coefficient 825 in multiplier 826. Metric 830 may be squared in square execution unit 836, and then the squared metric 830 (i.e., output of unit 836) may be multiplied by coefficient 835 in multiplier 837. The results of multipliers 816, 826, and 837 and offset 805 may be added in adder 845 to generate frequency sensitivity value 850. In other embodiments, adder 845 may be split up into two or more adders to more efficiently add together the various terms.

The example illustrated in FIG. 8 is for illustrative purposes only, and in other embodiments, other configurations of frequency sensitivity calculation units may be utilized. For example, in one embodiment, a frequency sensitivity calculation unit may utilize a single multiplier with a single metric and a single coefficient (i.e., FreqSensitivity=Metric1*Coefficient1). As shown in FIG. 8, frequency sensitivity calculation unit 800 may be implemented by dedicated hardware circuits. In other embodiments, frequency sensitivity calculation unit 800 may be implemented in software. In various embodiments, frequency sensitivity calculation unit 800 may be implemented by a combination of dedicated hardware circuits and software.

In some embodiments, frequency sensitivity calculation unit 800 may be utilized for a single processing unit or processor core within a multi-processor computer system. In such cases, there may be a separate frequency sensitivity calculation unit for each unit or core in the system. In other embodiments, frequency sensitivity calculation unit 800 may be utilized for the plurality of processing units or processor cores within a multi-processor computer system.

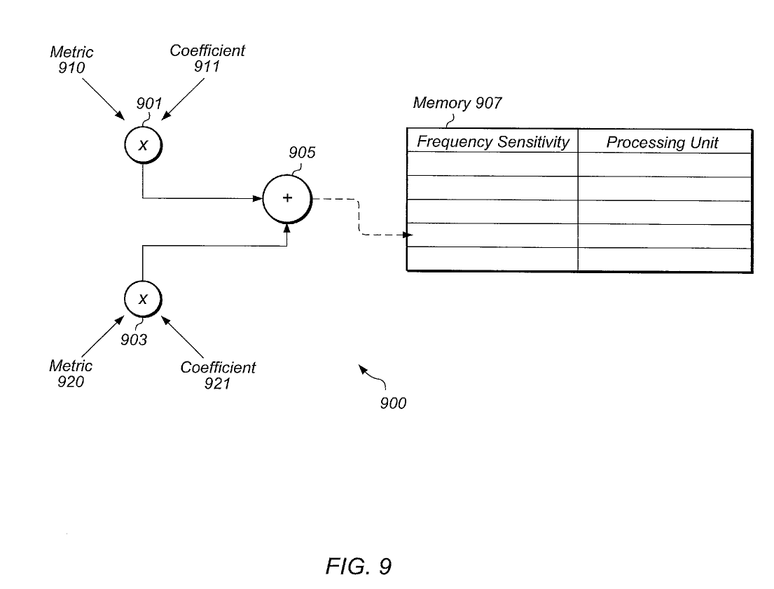

Referring now to FIG. 9, a block diagram of another embodiment of a frequency sensitivity calculation unit is shown. In one embodiment, frequency sensitivity calculation unit 900 may be utilized for determining the frequency sensitivity of a processing unit. Frequency sensitivity calculation unit 900 may store the frequency sensitivity value in memory 907 on an interval basis. An OS, another software program, or a dedicated hardware circuit may utilize the frequency sensitivity values stored in memory 907 to make determinations regarding clock frequency adjustments for one or more processing units.

Frequency sensitivity calculation unit 900 may include multiplier 901, and multiplier 901 may multiply metric 910 by coefficient 911. Metric 910 may be any of the various metrics previously described. Frequency sensitivity calculation unit 900 may also include multiplier 903, and multiplier 903 may multiply metric 920 by coefficient 921. Adder 905 may add the results of multiplier 901 and 903, and then the result of adder 905 may be stored in memory 907. The model shown in FIG. 9 may have been determined during a characterization stage. In other embodiments, other models with various metrics, coefficients, and arithmetic operators may be utilized to generate a frequency sensitivity value.

Generally speaking, the methods and mechanisms described herein may include any non-transitory storage media accessible by a computer during use to provide instructions and/or data to the computer. For example, a computer accessible storage medium may include storage media such as magnetic or optical media, e.g., disk (fixed or removable), tape, CD-ROM, or DVD-ROM, CD-R, CD-RW, DVD-R, DVD-RW, or Blu-Ray. Storage media may further include volatile or non-volatile memory media such as RAM (e.g. synchronous dynamic RAM (SDRAM), double data rate (DDR, DDR2, DDR3, etc.) SDRAM, low-power DDR (LPDDR2, etc.) SDRAM, Rambus DRAM (RDRAM), static RAM (SRAM), etc.), ROM, Flash memory, non-volatile memory (e.g. Flash memory) accessible via a peripheral interface such as the Universal Serial Bus (USB) interface, etc. Storage media may include microelectromechanical systems (MEMS), as well as storage media accessible via a communication medium such as a network and/or a wireless link.

It is noted that the above-described embodiments may comprise software. In such an embodiment, program instructions and/or a database (both of which may be referred to as “instructions”) that represent the described methods and/or apparatus may be stored on a computer readable storage medium. Program instructions on the computer readable storage medium may be read by a program and used, directly or indirectly, to fabricate the hardware comprising the systems described herein. For example, the program instructions may be a behavioral-level description or register-transfer level (RTL) description of the hardware functionality in a high level design language (HDL) such as Verilog or VHDL. The description may be read by a synthesis tool which may synthesize the description to produce a netlist comprising a list of gates from a synthesis library. The netlist comprises a set of gates which also represent the functionality of the hardware comprising the system. The netlist may then be placed and routed to produce a data set describing geometric shapes to be applied to masks. The masks may then be used in various semiconductor fabrication steps to produce a semiconductor circuit or circuits corresponding to the system. Alternatively, the database on the computer accessible storage medium may be the netlist (with or without the synthesis library) or the data set, as desired. While a computer accessible storage medium may carry a representation of a system, other embodiments may carry a representation of any portion of a system, as desired, including an IC, any set of agents (e.g., processing units, I/O interface, power management unit, etc.) or portions of agents (e.g., decision unit, CIPS unit, etc.).

Types of hardware components, processors, or machines which may be used by or in conjunction with the present invention include Application Specific Integrated Circuits (ASICs), Field Programmable Gate Arrays (FPGAs), microprocessors, or any integrated circuit. Such processors may be manufactured by configuring a manufacturing process using the results of processed hardware description language (HDL) instructions (such instructions capable of being stored on a computer readable media). The results of such processing may be maskworks that are then used in a semiconductor manufacturing process to manufacture a processor which implements aspects of the methods and mechanisms described herein.

Although the features and elements are described in the example embodiments in particular combinations, each feature or element can be used alone without the other features and elements of the example embodiments or in various combinations with or without other features and elements. The present invention may be implemented in a computer program or firmware tangibly embodied in a computer-readable storage medium having machine readable instructions for execution by a machine, a processor, and/or any general purpose computer for use with or by any non-volatile memory device. Suitable processors include, by way of example, both general and special purpose processors.

Although several embodiments of approaches have been shown and described, it will be apparent to those of ordinary skill in the art that a number of changes, modifications, or alterations to the approaches as described may be made. Changes, modifications, and alterations should therefore be seen as within the scope of the methods and mechanisms described herein. It should also be emphasized that the above-described embodiments are only non-limiting examples of implementations.

What is claimed is:

1. A system comprising:
an adjustable input clock that may be set to one of at least two or more frequencies;
a processing unit;
a power management unit; and
one or more performance counters;
wherein the power management unit is configured to:
calculate a real-time frequency sensitivity value of an application executing on the processing unit based on one or more values represented by said counters, wherein the real-time frequency sensitivity value represents a measure of how the performance of the processing unit while executing said application scales in relation to a frequency of the input clock; and
adjust a frequency of the input clock based on the real-time frequency sensitivity value.

2. The system as recited in claim 1, further comprising:
a storage device; and
one or more pre-defined workloads;
wherein for each of said one or more pre-defined workloads, the power management unit is configured to:
store a performance value of the processing unit at two or more input clock frequencies; and
store a measurement of each of the one or more performance counters at the one or more clock frequencies;
wherein the system is further configured to:
calculate a training session frequency sensitivity value for each of the one or more pre-defined workloads; and
generate a representation of a relationship between performance and frequency for each of the one or more pre-defined workloads.

3. The system as recited in claim 2, wherein to generate said representation of the relationship, the system is configured to perform linear regression on the one or more stored measurements of the one or more performance counters to match the training session frequency sensitivity value of each of the one or more pre-defined workloads, wherein performing linear regression produces one or more coefficients to apply to one or more performance counters.

4. The system as recited in claim 3, wherein in response to determining linear regression does not produce results that meet a predetermined accuracy level, the system is further configured to perform polynomial regression.

5. The system as recited in claim 1, wherein the one or more performance counters measure one or more of instructions per cycle (IPC), memory controller bandwidth, committed instructions per second (CIPS), cache hits, cache misses, branch mispredictions, instructions issued, interrupts, non-cache accesses, and/or pipeline stalls.

6. The system as recited in claim 1, wherein the power management unit is further configured to make thread scheduling decisions based on the real-time frequency sensitivity value.

7. The system as recited in claim 1, wherein the power management unit is further configured to:
receive a request to adjust the clock frequency; and
determine whether to comply with the request based on the real-time frequency sensitivity value.

8. A method comprising:
monitoring performance of a processing unit;
determining values of one or more hardware performance counters;
calculating a real-time frequency sensitivity value of an application executing on the processing unit based on one or more values represented by said counters, wherein the real-time frequency sensitivity value represents a measure of how the performance of the processing unit while executing said application scales in relation to a frequency of the input clock; and
adjusting a frequency of the input clock based on the real-time frequency sensitivity value.

9. The method as recited in claim 8, further comprising:
for each of one or more pre-defined workloads:
storing a performance value of the processing unit at two or more input clock frequencies;
storing a measurement of each of the one or more performance counters at one or more clock frequencies;
calculating a training session frequency sensitivity value for each of the one or more pre-defined workloads; and
generating a representing representation of a relationship between performance and frequency for each of the one or more pre-defined workloads.

10. The method as recited in claim 9, wherein to generate said representation of the relationship, the method further comprises performing linear regression on the one or more stored measurements of the one or more performance counters to match the training session frequency sensitivity value of each of the one or more pre-defined workloads, wherein performing linear regression produces one or more coefficients to apply to one or more performance counters.

11. The method as recited in claim 8, wherein the one or more performance counters measure one or more of instructions per cycle (IPC), memory controller bandwidth, committed instructions per second (CIPS), cache hits, cache misses, branch mispredictions, instructions issued, interrupts, non-cache accesses, and/or pipeline stalls.

12. The method as recited in claim 8, further comprising making thread scheduling decisions based on the real-time frequency sensitivity value.

13. The method as recited in claim 8, further comprising:
receiving a request to adjust the clock frequency; and
determining whether to comply with the request based on the real-time frequency sensitivity value.

14. The method as recited in claim 9, wherein in response to determining linear regression does not produce results that meet a predetermined accuracy level, the method comprises performing polynomial regression.

15. A non-transitory computer readable storage medium comprising program instructions, wherein when executed the program instructions are operable to:
monitor performance of a processing unit;
determine values of one or more hardware performance counters;
calculate a real-time frequency sensitivity value of an application executing on the processing unit based on one or more values represented by said counters, wherein the real-time frequency sensitivity value represents a measure of how the performance of the processing unit while executing said application scales in relation to a frequency of the input clock; and
adjust a frequency of the input clock based on the real-time frequency sensitivity value.

16. The non-transitory computer readable storage medium as recited in claim 15, wherein the program instructions are further operable to:
for each of one or more pre-defined workloads:
store a performance value of the processing unit at two or more input clock frequencies;
store a measurement of each of the one or more performance counters at one or more clock frequencies
after the training session:
calculate a training session frequency sensitivity value for each of the one or more pre-defined workloads; and
generate a representing representation of a relationship between performance and frequency for each of the one or more pre-defined workloads.

17. The non-transitory computer readable storage medium as recited in claim 16, wherein to generate said representation of the relationship, the program instructions are further operable to perform linear regression on the one or more stored measurements of the one or more performance counters to match the training session frequency sensitivity value of each of the one or more pre-defined workloads, wherein performing linear regression produces one or more coefficients to apply to one or more performance counters.

18. The non-transitory computer readable storage medium as recited in claim 15, wherein the one or more performance counters measure one or more of instructions per cycle (IPC), memory controller bandwidth, committed instructions per second (CIPS), cache hits, cache misses, branch mispredictions, instructions issued, interrupts, non-cache accesses, and/or pipeline stalls.

19. The non-transitory computer readable storage medium as recited in claim 15, wherein the program instructions are operable to make thread scheduling decisions based on the real-time frequency sensitivity value.

20. The non-transitory computer readable storage medium as recited in claim 15, wherein in response to determining linear regression does not produce results that meet a predetermined accuracy level, the program instructions are operable to perform polynomial regression.
